(19) United States
(12) Patent Application Publication
(10) Pub. No.: US 2012/0216149 A1
(43) Pub. Date: Aug. 23, 2012

(54) METHOD AND MOBILE APPARATUS FOR DISPLAYING AN AUGMENTED REALITY

(75) Inventors: Nam-wook KANG, Seoul (KR); Seung-eok Choi, Suwon-si (KR); Hak-soo Ju, Suwon-si (KR); Jong-hyun Ryu, Suwon-si (KR); Sin-ae Kim, Suwon-si (KR)

(73) Assignee: Samsung Electronics Co., Ltd., Suwon-si (KR)

(21) Appl. No.: 13/242,935

(22) Filed: Sep. 23, 2011

(30) Foreign Application Priority Data
Feb. 18, 2011 (KR) 10-2011-0014797

(51) Int. Cl. G06T 15/00; G06F 3/048; G09G 5/00

(52) U.S. Cl. 715/848; 345/419

(57) ABSTRACT

A mobile apparatus and method for displaying an Augmented Reality (AR) in the mobile apparatus. The mobile apparatus captures an image of a current environment of the mobile apparatus, displays the image, detects mapping information corresponding to the current environment from among mapping information stored in the mobile apparatus, maps a three-dimensional (3D) Graphical User Interface (GUI) of detected mapping information onto the displayed image, based on a relative location relationship between the detected mapping information, and adjusts a display status of the 3D GUI, while maintaining the relative location relationship between the detected mapping information.

### PRIORITY

This application claims priority under 35 U.S.C. §119(a) to Korean Patent Application No. 10-2011-0014797, which was filed in the Korean Intellectual Property Office on Feb. 18, 2011, the entire disclosure of which is incorporated herein by reference.

### BACKGROUND OF THE INVENTION

1. Field of the Invention

The present invention relates generally to a method and mobile apparatus for displaying an Augmented Reality (AR), and more particularly, to a method and mobile apparatus that map mapping information stored in the mobile apparatus onto a street view and displays a mapping result as an AR.

2. Description of the Related Art

In most mobile apparatuses, e.g., cell phones, a user can capture images using a camera included in the mobile terminal and can determine a current location using a Global Positioning System (GPS) module, which is also included in the mobile apparatus.

Currently, in the field of Augmented Reality (AR), research is underway for providing the user with additional information by displaying new additional information, such as a virtual graphic image, on an image being displayed by the mobile apparatus, e.g., which is captured by the camera.

More specifically, AR adds a virtual world including additional information to an actual world that the user views to form a type of virtual reality. The concept of AR is to complement the actual world using the virtual world. For example, even if virtual surroundings formed using computer graphics, the basis of the AR is the user's actual surroundings. Computer graphics are used to provide additional information to the actual surroundings. By overlapping an actual image that the user is viewing with a three-Dimensional (3D) virtual image, any distinctions between the actual surroundings and the virtual image are blurred.

A conventional method for using AR is to identify current location information, to receive near geographic information from a server, and then to render the information on a 3D structure. However, when the user is traveling abroad or when the user cannot communicate with the server, the geographic information of the surrounding area cannot be displayed in the AR.

Additionally, even if the geographic information is displayed, if the location and direction of the mobile apparatus is not accurately detected, it is difficult to accurately map the geographic information on the actual display, e.g., to provide a street view.

### SUMMARY OF THE INVENTION

The present invention has been developed in order to overcome the above-described drawbacks and other problems associated with a conventional AR arrangement, and provide at least the advantages described below.

Accordingly, an aspect of the present invention is to provide a method and mobile apparatus that can map mapping information onto a street view, and then display it as an AR.

In accordance with an aspect of the present invention, a method of displaying an AR is provided for a mobile apparatus. The method includes capturing, by the mobile apparatus, an image of a current environment of the mobile apparatus; displaying the image; detecting mapping information corresponding to the current environment from among mapping information stored in the mobile apparatus; mapping a three-dimensional (3D) Graphical User Interface (GUI) of detected mapping information onto the displayed image, based on a relative location relationship between the detected mapping information; and adjusting a display status of the 3D GUI, while maintaining the relative location relationship between the detected mapping information.

In accordance with another aspect of the present invention, a mobile apparatus for providing an AR is provided. The mobile apparatus includes a camera that captures an image of a current environment of the mobile apparatus; a display that displays the image of the current environment along with a three-dimensional (3D) GUI of detected mapping information; a memory that stores mapping information; a Graphical User Interface (GUI) processor that detects mapping information corresponding to the current environment from among the mapping information stored in the memory and maps the 3D GUI of the detected mapping information on the current environment, based on a relative location relationship between the detected mapping information; and a controller that controls the GUI processor to adjust a display status of the 3D GUI, while maintaining the relative location relationship between the detected mapping information.

### BRIEF DESCRIPTION OF THE DRAWINGS

The above and/or other aspects, feature, and advantages of certain embodiments of the present invention will become apparent and more readily appreciated from the following description of these embodiments, taken in conjunction with the accompanying drawings, in which:

FIG. 1 is a block diagram illustrating a mobile apparatus according to an embodiment of the present invention;

FIG. 2 illustrates screen images displaying mapping information of a mobile apparatus according to an embodiment of the present invention;

FIG. 3 illustrates generating mapping information related to a street view in a mobile apparatus according to an embodiment of the present invention;

FIGS. 4 to 6 illustrate mapping information related with a street view in a mobile apparatus according to an embodiment of the present invention;

FIGS. 7 to 9 illustrate a method for adjusting a display status of mapping information in a mobile apparatus according to an embodiment of the present invention; and

FIG. 10 is a flow chart illustrating a method of displaying an AR in a mobile apparatus according to an embodiment of the present invention.

Throughout the drawings, like reference numerals will be understood to refer to like parts, components and structures.

### DETAILED DESCRIPTION OF EMBODIMENTS OF THE INVENTION

Hereinafter, various embodiments of the present invention will be described in detail with reference to the accompanying drawings. The present invention may, however, be embodied in many different forms and should not be construed as limited to the embodiments set forth herein. Rather, these embodiments are provided so that this disclosure will be thorough and complete and will fully convey the scope of the invention to those skilled in the art.

In a following disclosure, a mobile apparatus is a portable apparatus including a camera and a display. For example, the mobile apparatus which embodiments of the present invention can be applied may include various kinds of electronic apparatuses such as a digital camera, a cellular phone, a Personal Digital Assistant (PDA), a tablet Personal Computer (PC), a note-book PC, a digital photo frame, a navigation terminal, an MP3 player, etc.

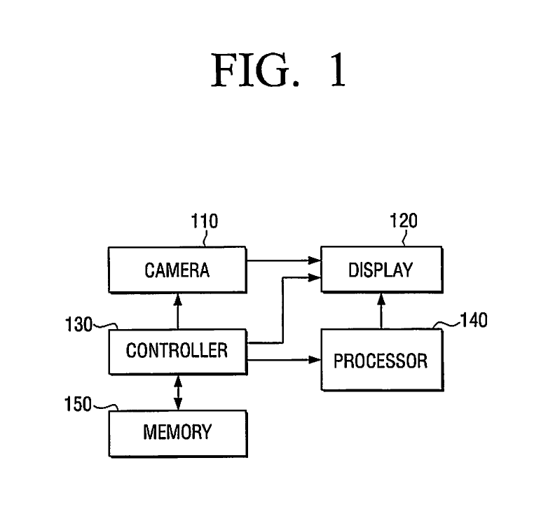

FIG. 1 is a block diagram illustrating a mobile apparatus according to an embodiment of the present invention.

Referring to FIG. 1, the mobile apparatus includes a camera 110, a display 120, a controller 130, a Graphical User Interface (GUI) processor 140, and a memory 150.

The camera 110 receives captures an image, and outputs photographed image data. For example, the camera 110 may include a Charge-Coupled Device (CCD) or a Complementary Metal-Oxide Semiconductor (CMOS) image sensor. Accordingly, the camera 110 captures an image using an array image sensor (two-dimensional image sensor).

The display 120, e.g., a Liquid Crystal Display (LCD) screen, displays the image data photographed by the camera 110. In following description, all images that are photographed by the camera 110 and are displayed on the display 120 will be referred to as “a street view”. That is, the term street view does not mean only an image of an actual street that is photographed, but an image of the entire surroundings that are photographed by the mobile apparatus, i.e., a current environment of the mobile apparatus. Accordingly, features such as buildings, roads, trees, geographic features, etc., which are within a photographing direction and a photographing range of the mobile apparatus are displayed on the display 120.

The GUI processor 140 generates GUI images, which will be mapped onto a street view that is being displayed on the display 120. Specifically, when the user selects an AR menu or when the AR function is set in default, the GUI processor 140 maps various kinds of mapping information onto the surrounding image displayed on the display 120. Further, the GUI processor 140 detects mapping information that will be mapped onto the current street view from the memory 150.

The memory 150 stores various kinds of mapping information. For example, the mapping information may include geographical information with respect to various artificial and natural features or geography, such as buildings, cities, mountains, rivers, fields, trees, etc., within an area corresponding to the street view, search information that represents results of a search that was previously performed or has been newly performed with respect to the geographical information, and related information, which is obtained relating to activities performed in the area corresponding to the street view.

For example, the search information may include information about restaurants, shops, cultural assets, attractions, etc., which have been registered in the corresponding area. Also, the related information may include use information of credit cards that have been used within the area corresponding to the street view, image data that has been captured within the area, message information, Social Networking Service (SNS) information, and e-mail information that have been transmitted or received within the area, and text or image file information that has been made or read within the area.

In other words, the memory 150 stores information about geographic surroundings, or a variety of information related to the geographic surroundings as mapping information. The mapping information may include location information about places in which the mapping information has been used or location information about places from which the mapping information has been obtained from. For example, the location information may be absolute coordinates, indicated using longitude and latitude, or text information, such as addresses, administrative district names, street numbers, etc., which are prescribed in the area which the mobile apparatus is used.

A mapping relationship between the mapping information and actual places on which each of the mapping information is mapped may also be stored in the memory 150. For example, when a user searches about a specific place, uses a credit card, takes a picture, transmits/receives e-mails or messages, connects to an SNS, makes or reads a file, etc., in a specific place, the user may input a command to map a result on a corresponding place, thereby manually mapping the mapping information on the places. Also, after the activity is finished, the result and the corresponding place may be automatically mapped and then saved in the memory 150.

The GUI processor 140 detects mapping information corresponding to a current street view among the mapping information stored in the memory 150, based on a current location and a photographing direction of the mobile apparatus. For example, if the location information is expressed as absolute coordinates, the GUI processor 140 detects mapping information having longitude and latitude in a range between a maximum longitude and latitude and a minimum longitude and latitude of areas that are included in the current street view.

The GUI processor 140 obtains a relative location relationship by comparing the latitude and longitude of the detected mapping information. The relative location relationship can be expressed a distance and a direction between the mapping information, i.e., a distance and a direction between two places on which the mapping information is displayed. Also, the distance and direction between the mapping information may be calculated according to a current location of the mobile apparatus, location information of the mapping information, photography magnification, a screen size, an actual distance between photographed objects, etc.

For example, if a first building on which information “a” is expressed and a second building on which information “b” is expressed are approximately 40 m from each other, the screen size is about 4 cm, and width of the area that is displayed on the screen is approximately 80 m, the distance between the information “a” and the information “b” on the screen may be expressed by the length of about 2 cm. If the image is magnified ½ times by a zoom-out, the distance between the information “a” and the information “b” on the screen is reduced to and displayed by the length of approximately 1 cm. However, if the image is magnified 2 times by a zoom-in, the distance between the information “a” and the information “b” on the screen is enlarged to and displayed by the length of approximately 4 cm.

Additionally, the display directions and heights of the information “a” and the information “b” are displayed according to locations of the first building and the second building and a current location of the user. In other words, if the first building is closer to the user, the information “a” is arranged in a front portion of the screen and the information “b” is arranged in a back portion of the screen.

The GUI processor 140 may determine a relative location relationship between mapping information based on the relationship between the location-coordinates of the mapping information, the current location of the mobile apparatus, etc. The GUI processor 140 can also control the GUI to maintain the determined location relationship as it is.

Accordingly, the location of the mobile apparatus can be calculated using GPS information. However, it may be difficult to accurately calculate the location and orientation of the mobile apparatus. As a result, mapping the mapping information on the street view, which is currently displayed on the screen, may be not accurately performed.

For example, when the mobile apparatus is oriented to the north at a point of (x, y), the information “a” and the information “b” may be accurately mapped and may be accurately displayed on the screen so that the information “a” is a picture information that was taken from the tenth floor of the first building and the information “b” is a card information that was used at a shop on the first floor of the second building. However, the actual mobile apparatus may measure the location thereof with some error range, such as a point of (x+a, y+b). Consequently, the information “a” may be displayed on a third building instead of the first building, and the information “b” may be displayed in the air.

In this case, the user can adjust mapping locations of the information “a” and information “b” via an input device (not shown) of the mobile apparatus. In other words, based on a user's manipulation, the controller 130 controls the display status of the GUI and can change the displaying location of the mapping information. For example, the user can touch the screen, and then, drag the screen. Based on the drag direction and the drag distance, the GUI can rotate while maintaining its shape as it is. Accordingly, if one among many mapping information is mapped on an accurate location, the other mapping information can be also mapped on accurate locations.

For another example, the user can rotate or move the mobile apparatus. At this time, the status of the current GUI is maintained as it is and the street view is changed so that mapping may be performed. Also, regardless of change of the street view, the controller 130 may control the GUI processor 140 to automatically rotate the GUI according to a direction of or a direction opposite to the movement of the user.

As described above, the mobile apparatus maps various information, which is stored in the mobile apparatus, onto a street view and displays the mapped street view as an AR. Therefore, even if the mobile apparatus is not connected to the server, it can still display AR images.

Specially, the mapping information that is used to form the AR image has relative location relationship between the information. Accordingly, based on manipulation of the user, a position at which the mapping information is displayed can be changed, while maintaining the location relationship therebetween. As a result, the user can place mapping information on a landmark, which the user knows, and can use the mapping information on the known landmark as a reference. Due to the mapping information, which became the reference, other mapping information can be automatically mapped onto accurate locations. The user can change the reference by using a screen touch, movement of the mobile apparatus, etc. If the reference is changed, the display positions of entire mapping information are adjusted according to the changed reference.

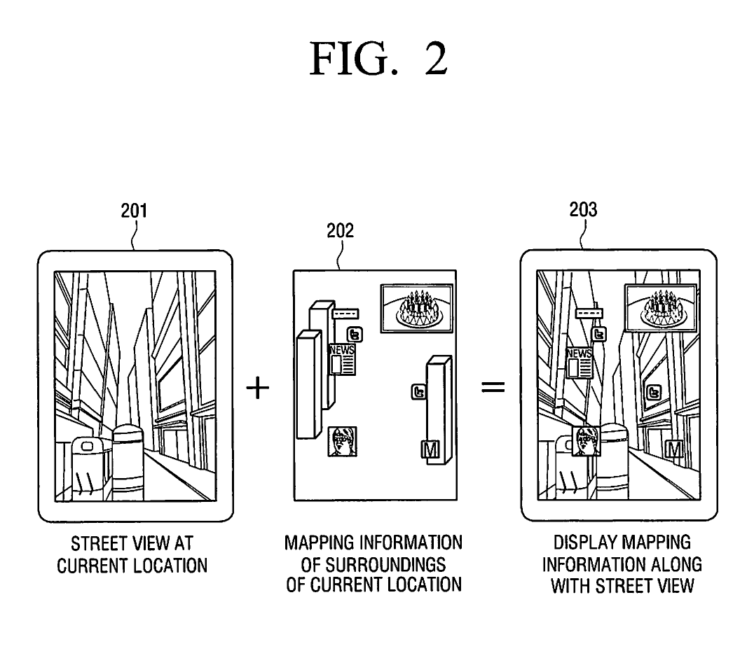

FIG. 2 illustrates mapping information displayed on a mobile apparatus according to an embodiment of the present invention.

Referring to FIG. 2, a street view of a current location 201 and mapping information of the surroundings of the current location 202 are displayed together on the mobile apparatus in image 203. As described above, the mapping information 202, which is included on the street view of the surroundings of the current location can be detected among a variety of information, which was pre-stored in the memory 150 of the mobile apparatus according to an embodiment of the present invention. In other words, the mapping information 202, which is mapped on the street view of the surroundings of the current location in image 203, is not received from a separate server, but is retrieved from the memory 150 of the mobile apparatus itself.

As described above, the mapping information may include location information. The GUI processor 140 or the controller 130 can compare the location information of each of the mapping information with the location information of each of features in the current street view to confirm whether or not each of the mapping information is related to the current street view.

Also, as described above, mapping relationship between mapping information and locations in the street view on which the mapping information is mapped may be manually or automatically set, and then may be stored in the memory 150.

For example, while the user is moving to various places, the user can tag information related to the places on the mobile apparatus. Accordingly, 3D map information can be generated based on mapping information generated by the user. This process can be performed even when the mobile apparatus cannot communicate with the server. Therefore, even if the mobile apparatus cannot receive a map information service, the mobile apparatus can still generate information related to each place and generate mapping information that will be mapped onto the street view, e.g., by drawing a picture or a rough map on blank paper.

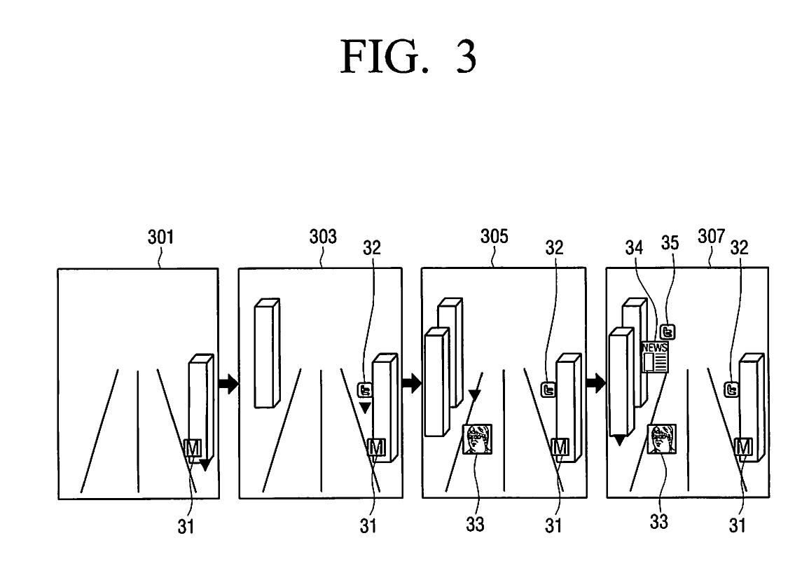

FIG. 3 illustrates generating mapping information in a mobile apparatus according to an embodiment of the present invention.

Referring to FIG. 3, as indicated above, while the user is moving to various places, e.g., buildings, the user can manually or automatically tag information with respect to actions that are performed at each of the buildings, i.e., related information to corresponding places. In other words, as illustrated in screen 301 of FIG. 3, when tagging information that the user transmits or receives an e-mail in a building, mapping information representing transmission/reception of an e-mail in the corresponding location is generated in a shape of a GUI icon 31. Additionally, an image of the building can also be generated as a GUI along with the icon 31.

As illustrated in screen 303 of FIG. 3, when the user uses an SNS, e.g., twitter®, on an upper floor of the building, mapping information representing twitter® is displayed as a GUI icon 32. Similarly, when the user takes a picture on the street while moving to another building, as illustrated in screen 305 of FIG. 3, mapping information representing the picture is displayed as a GUI icon 33 on the street. In addition, when the user reads news and uses twitter® in another building, as illustrated in screen 307 of FIG. 3, a news GUI icon 34 and a twitter® GUI icon 35 are additionally displayed.

As described above, mapping information, which is generated by the works performed in the mobile apparatus, is saved having relative location relationship between each other. At this time, images of the buildings can be generated in graphics and saved along with the mapping information. Therefore, the building images also may be explained to be included in the mapping information. Locations of the mapping information are determined relatively with respect to each other. Therefore, when the user changes the reference, the locations of the other mapping information are changed according to the changed reference. At this time, the relative location relationship therebetween may be maintained as it is.

As described above, the related information can include the card use information. That is, if the user uses a credit card in a specific building, the mobile apparatus can receive a message for verifying card use from a card company. The memory 150 can automatically save the received message itself or information detected from the message such as a card spending amount, a card use time, etc., as mapping information. Also, the information can be manually saved. In other words, when the user receives the message of the card use after using the card, the user can select a menu for saving the message as mapping information and then save the message as the mapping information. For example, the information, such as the card spending amount, the card use time, etc., which is related to information of the location at which the card was used can be saved.

In accordance with another embodiment of the present invention, information about a picture taken by the user can be automatically (or manually) stored as mapping information. For example, when the user takes a picture of a specific building included in the street view, information with respect to the picture may be automatically (or manually) stored in the memory 150. Therefore, not only the picture itself, but also supplementary information such as a location, date, and time at which the picture was taken, a title of the picture, etc., can be used as mapping information.

In accordance with another embodiment of the present invention, Short Message Service (SMS) messages or Multimedia Message Service (MMS) messages that are transmitted or received in a specific place can be saved in the memory 150 as the mapping information. For example, the time when the message is transmitted or received, information about a part of the message, etc., can be used as mapping information, along with the message itself.

The display 120 displays the street view, and displays mapping information on the street view. The mapping information is provided from the GUI processor 140.

If the mapping information includes building images, the display 120 maps x, y, z coordinates of each of the building images of the mapping information on location coordinates, i.e., x, y, z coordinates of each of the buildings on the street view, and then displays the mapped image. More specifically, the mobile apparatus uses x, y, z coordinates of the reference building for synchronizing the actual building on the street view, which is photographed by the camera of the mobile apparatus, with the building image for an AR image.

Further, the mapping relationship between the mapping information and the street view can be adjusted through manipulation by the user. For example, when the user touches and drags the screen, moves the mobile apparatus, or operates direction keys, the x, y, z coordinates of the mapping information is changed according to the user's manipulation. The relative location relationship between the mapping information is maintained as it is.

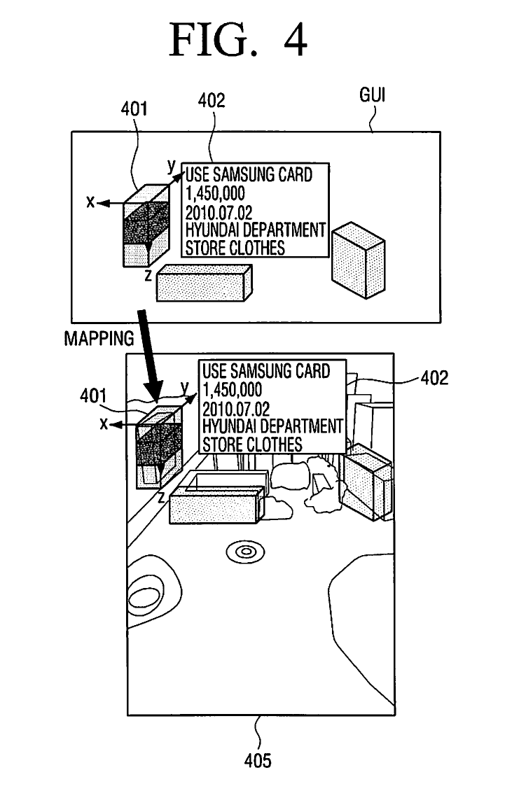

FIGS. 4 to 6 illustrate a mobile apparatus saving mapping information related to a street view and using x, y, z coordinates to display a building image matched with a reference building on the street view, according to an embodiment of the present invention.

Referring to FIG. 4, information about a credit card transaction in a specific building can be stored as mapping information. At this time, an image 401 of the building and the card use information 402 can be generated as GUIs. Axes of x, y, z for determining the reference of the GUI can be also displayed on the screen. Then, when the street view and mapping information are mapped and displayed together as illustrated in screen 405 of FIG. 4, the user can rotate the axes of x, y, z and adjust the GUI so that the GUI of the building is accurately mapped on the actual building.

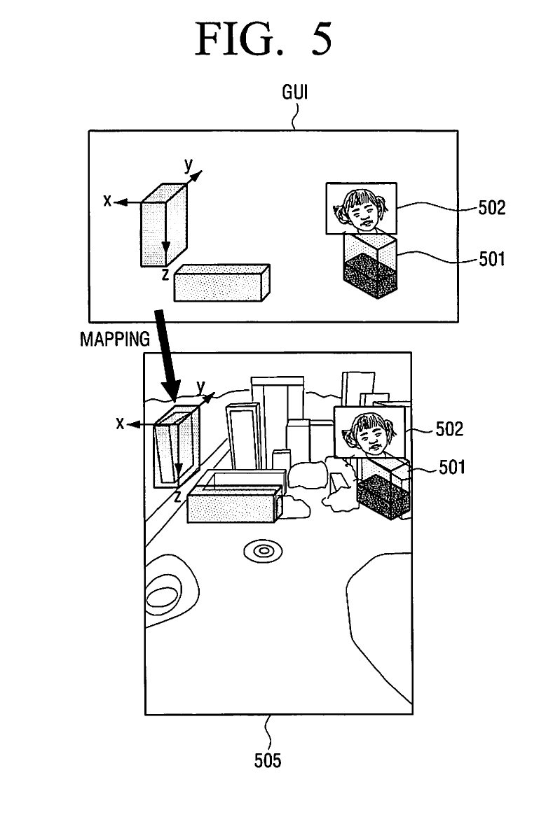

FIG. 5 illustrates an example in which picture information is used as mapping information. As illustrated in FIG. 5, when a picture is taken, an image 501 about a place at which the picture is taken and mapping information 502 about the picture are generated as GUIs. The generated GUIs are mapped on the actual street view in screen 505. The user can adjust the displayed reference of the GUIs so that the image 501 or the mapping information 502 is mapped accurately on the building image.

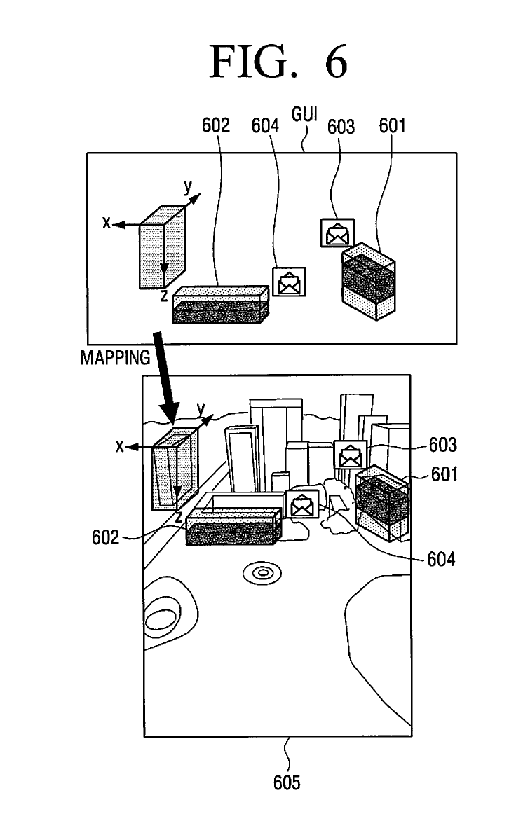

FIG. 6 illustrates an example in which message use information is used as mapping information. Referring to FIG. 6, when messages are transmitted or received, images 601 and 602 about place at which the messages are transmitted or received and mapping information 603 and 604 about the messages use are generated as GUIs. The generated GUIs are mapped on the street view in screen 605.

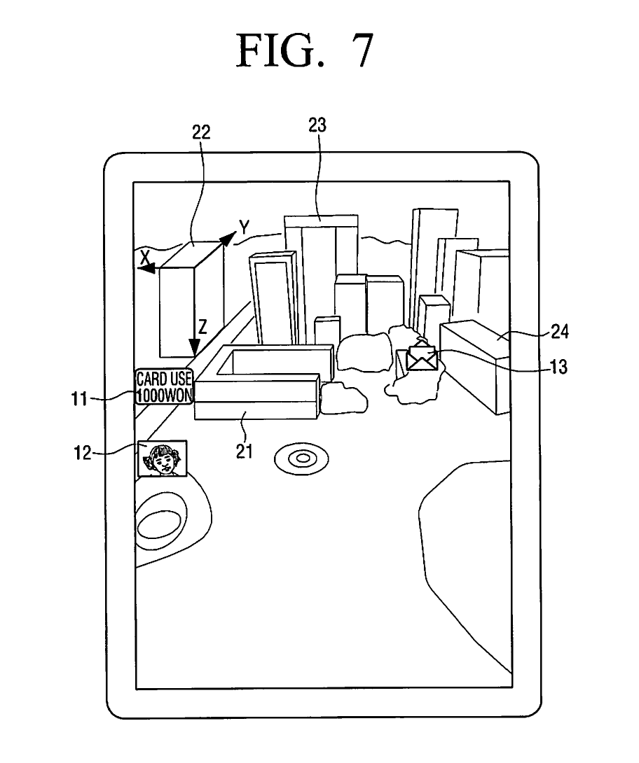

FIGS. 7 to 9 illustrate a method for adjusting a display status of mapping information in a mobile apparatus according to an embodiment of the present invention. Unlike FIGS. 4 to 6, in FIG. 7, the GUI for a building image is omitted, and only mapping information is displayed as a GUI.

FIG. 7 illustrates an example in which card use information 11, picture information 12, and message information 13 are used as mapping information. Each of the mapping information is displayed on a location at which the mapping information is generated. However, the mapping information may not accurately align with the actual street view. In other words, as illustrated in FIG. 7, the mapping information 11, 12 and 13 does not accurately overlap the actual building images 21, 22, 23 and 24 on the screen.

Accordingly, a user may manipulate the GUI to adjust the locations at which the mapping information 11, 12 and 13 are displayed. During adjustment, the location of each of the mapping information is changed, while the relative location relationship therebetween is maintained as it is.

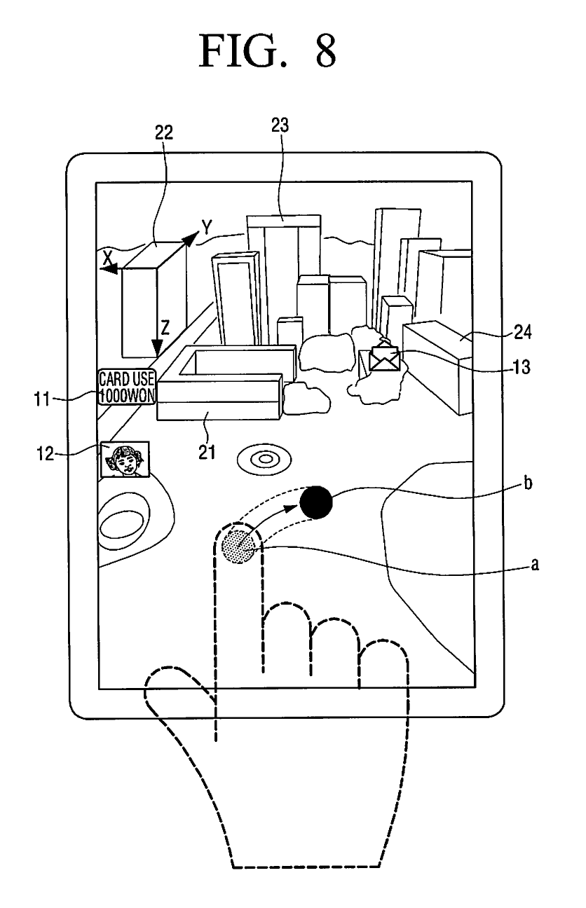

Specifically, as illustrated in FIG. 8, the user touches and drags from point a to point b on the screen. Here, adjustment level of the GUI is determined according to a dragging passage and a dragging distance from the point a, which was first touched, to the point b at which the dragging is finished. For example, if the user drags along a curved line from the point a to the point b, the axes of x, y, z on which mapping information 11, 12 and 13 is arranged are also rotated corresponding to the status of the dragging. The user drags while visually checking the movement of the mapping information 11, 12 and 13 in order to map one of the mapping information on the reference building. For example, the user can map the picture information 12 on the first building image 21. At this time, the other mapping information 11 and 13 is moved in the same direction, and then is mapped on corresponding building images.

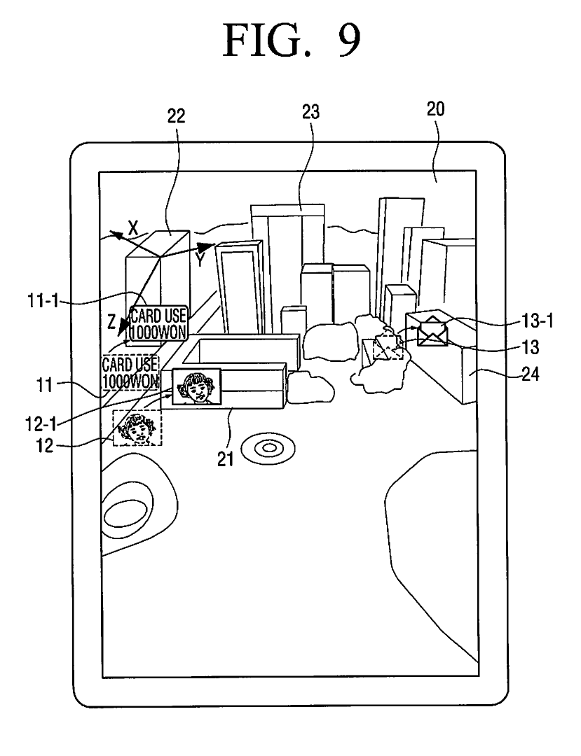

As a result, as illustrated in FIG. 9, the mapping information 11, 12, and 13 is moved onto the actual building images 22, 21, and 24, and then is displayed on new locations 11-1, 12-1, and 13-1.

However, a moving distance of each of the mapping information may be different corresponding to a distance from the mobile apparatus. In other words, first mapping information that is closer to the mobile apparatus moves a longer distance than second mapping information that is behind the first mapping information, i.e., farther from the mobile apparatus. As a result, while the relative location relationship is maintained as it is, the mapping can be performed.

Although in FIGS. 7 to 9, only related information is illustrated as the mapping information, as described above, geographic information can also be displayed as mapping information. That is, various mapping information, such as shops, restaurants, attractions, building names, street names, etc., can be included in the GUI, and can be mapped on the street view. Also, the display status of the mapping information can be changed corresponding to user manipulation, so as to be accurately mapped.

As described above, a mobile apparatus according to an embodiment of the present invention can generate AR by using various mapping information, which is stored in the mobile apparatus itself. As a result, because the mobile apparatus has lower dependence on a network connection, the mobile apparatus can more efficiently display the AR, even when not connected with a server.

Additionally, because the GUI can be changed by user manipulation, the mapping information and the street view can be accurately mapped with each other. The user can select one among the various mapping information as a reference of mapping information, and then, move the selected reference mapping information on a landmark corresponding to the selected reference mapping information. As a result, locations of total mapping information are accurately adjusted.

However, when the user does not know the landmark, the user can rotate the mapping information in various directions to search for a place on which the mapping information is accurately mapped. In other words, if while rotating the GUI the user determines that the total mapping information is mapped on proper places and there is no mapping information on the air space, the user can stop manipulating the mobile apparatus.

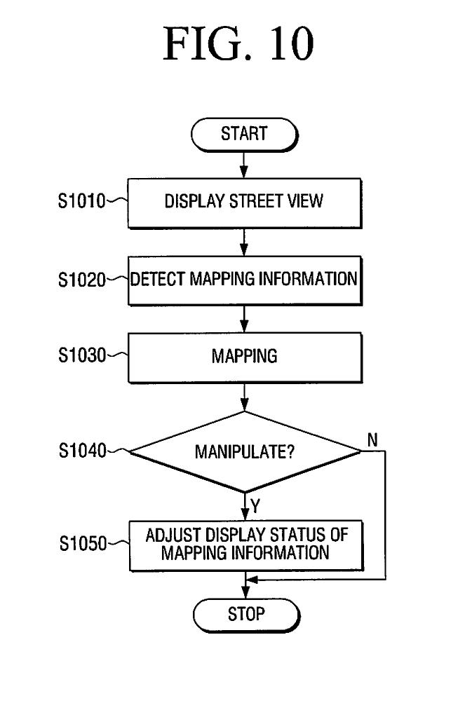

FIG. 10 is a flow chart illustrating a method for display an AR in a mobile apparatus according to an embodiment of the present invention.

Referring to FIG. 10, in step S1010, a user activates a camera of the mobile apparatus, which displays a street view of a current location that is photographed by the camera.

In step S1020, when an augmented reality menu is selected, when an augmented reality function is set in default, or when an application for displaying an AR is run, mapping information corresponding to the current street view is detected from the pre-stored information. Here, the mapping information can be detected by comparing location information, which was previously stored along with each of the mapping information, with location information of an area that is included in the current street view. Alternatively, the information that is tagged to each of buildings within the area of the current street view can be detected directly as the mapping information.

In step S1030, the detected mapping information is mapped onto the street view and displayed as AR image. At this time, the detected mapping information is displayed according to the relative location relationship between the mapping information. The mapping information can be displayed as GUIs.

When the user manipulates the mobile apparatus in step S1040, the display status of the mapping information is adjusted depending on the manipulation, while the relative location relationship between the mapping information is maintained as it is.

As described above, examples of user manipulations with which the user can adjust the display status of the GUI of the mapping information include directly touching and dragging the screen, by moving the mobile apparatus, and by manipulating the direction keys.

Information display methods according to various embodiments of the present invention can also be embodied as recordable program codes on various types of non-transitory recordable media. The program codes can be executed by Central Processing Units (CPUs) of various types of mobile apparatuses, such as cellular phones, PDAs, tablet PCs, e-books, navigation terminals, digital photo frames, etc., in which the recordable media are mounted so as to perform the information display method as described above.

More specifically, program code for performing the above information display methods may be stored in various types of recordable media readable by a mobile apparatus such as a Random Access Memory (RAM), a flash memory, a Read Only Memory (ROM), an Erasable Programmable ROM (EPROM), an Electronically Erasable and Programmable ROM (EEPROM), a register, a hard disk, a removable disk, a memory card, a Universal Serial Bus (USB) memory, and a Compact Disc (CD)-ROM, etc.

Although certain embodiments of the present invention have been shown and described above, it will be appreciated by those skilled in the art that various changes may be made in these embodiments without departing from the principles and spirit of the present invention, the scope of which is defined in the appended claims and their equivalents.

What is claimed is:

1. A method for displaying an Augmented Reality (AR) in a mobile apparatus, the method comprising the steps of:
capturing, by the mobile apparatus, an image of a current environment of the mobile apparatus;
displaying the image;
detecting mapping information corresponding to the current environment from among mapping information stored in the mobile apparatus;
mapping a three-dimensional (3D) Graphical User Interface (GUI) of detected mapping information onto the displayed image, based on a relative location relationship between the detected mapping information; and
adjusting a display status of the 3D GUI, while maintaining the relative location relationship between the detected mapping information.

2. The method of claim 1, wherein adjusting the display status of the 3D GUI comprises:
receiving a user manipulation input from a user of the mobile apparatus; and
adjusting the display status of the 3D GUI according to the user manipulation.

3. The method of claim 1, wherein adjusting the display status of the 3D GUI comprises:
receiving a touch and drag user manipulation input on a screen of the mobile apparatus; and
rotating the 3D GUI according to a direction of the touch and drag user manipulation input so as to adjust a display location of the detected mapping information.

4. The method of claim 1, wherein adjusting the display status of the 3D GUI comprises:
receiving a user manipulation input from a user of the mobile apparatus that changes a location or direction of the mobile apparatus; and
adjusting the display status of the 3D GUI according to the user manipulation input.

5. The method of claim 1, wherein the mapping information includes at least one of geographical information in an area corresponding to the current environment, search information in relation to the geographical information, related information obtained in relation to an activity performed in the area corresponding to the current environment.

6. The method of claim 5, wherein the related information includes at least one of use information related to credit card activity in the area corresponding to the current environment, image data related to a photograph taken within the area, and message information, Social Networking Service (SNS) information, and e-mail information related to messages, SNS activity, and e-mails that have been transmitted or received within the area, and text or image file information related to text or image files that have been made or read within the area.

7. The method of claim 1, wherein detecting the mapping information corresponding to the current environment comprises detecting mapping information from among the stored mapping information, which has location coordinates belonging to a location range identifying the area corresponding to the current environment.

8. The method of claim 7, wherein mapping the 3D GUI of the detected mapping information comprises:
comparing the location coordinates of the detected mapping information to set the relative location relationship;
arranging other mapping information at a display direction and distance that is determined according to the relative location relationship, based on a location of one of the detected mapping information so as to form the 3D GUI; and
mapping the 3D GUI to the current environment.

9. The method of claim 8, wherein adjusting the display status of the 3D GUI comprises:
receiving a user manipulation input from a user of the mobile apparatus; and
rotating, reducing, and enlarging the 3D GUI, while maintaining the display direction and distance between the mapping information.

10. A mobile apparatus for displaying an Augmented Reality (AR), the mobile apparatus comprising:
a camera that captures an image of a current environment of the mobile apparatus;
a display that displays the image of the current environment along with a three-dimensional (3D) GUI of detected mapping information;
a memory that stores mapping information;
a Graphical User Interface (GUI) processor that detects mapping information corresponding to the current environment from among the mapping information stored in the memory and maps the 3D GUI of the detected mapping information on the current environment, based on a relative location relationship between the detected mapping information; and
a controller that controls the GUI processor to adjust a display status of the 3D GUI, while maintaining the relative location relationship between the detected mapping information.

11. The mobile apparatus of claim 10, further comprising a input device that receives a user manipulation input from a user of the mobile apparatus,
wherein user manipulation input commands the controller to control the GUI processor to adjust the display status of the 3D GUI according to the user manipulation input.

12. The mobile apparatus of claim 11, wherein the input device comprises a touch screen,
wherein when the user manipulation input includes a touch and drag on the touch screen of the mobile apparatus, the controller portion controls the GUI processor to rotate the 3D GUI according to a direction of the touch and drag so as to adjust a display location of the detected mapping information.

13. The mobile apparatus of claim 10, wherein when a user changes a location or direction of the mobile apparatus, the controller controls the GUI processor to adjust the display status of the 3D GUI according to a change of the location or direction.

14. The mobile apparatus of claim 10, wherein the mapping information comprises at least one of:
geographical information in an area corresponding to the current environment;
search information in relation to the geographic information; and
related information in relation to an activity performed in the area corresponding to the current environment.

15. The mobile apparatus of claim 14, wherein the related information comprises at least one of”
use information related to credit card activity in the area corresponding to the current environment;
image data related to a photograph taken within the area; and
message information, Social Networking Service (SNS) information, and e-mail information related to messages, SNS activity, and e-mails that have been transmitted or received within the area, and text or image file information related to text or image files that have been made or read within the area.

16. The mobile apparatus of claim 10, wherein the GUI processor detects mapping information that has location coordinates belonging to a location range identifying the area corresponding to the current environment, compares the location coordinates of the detected mapping information to set the relative location relationship, and arranges other mapping information at a display direction and distance that is determined according to the relative location relationship, based on a location of one of the detected mapping information so as to form the 3D GUI.

17. The mobile apparatus of claim 16, further comprising an input device that receives a user manipulation input from a user of the mobile apparatus,
wherein when the input device receives the user manipulation input, the controller rotates, reduces, and enlarges the 3D GUI, while maintaining the display direction and distance between the mapping information.
